(19) United States
(12) Patent Application Publication
(10) Pub. No.: US 2017/0373917 A1
(43) Pub. Date: Dec. 28, 2017

(54) METHOD OF MOVING VIRTUAL ENTITY IN VIRTUAL NETWORK AND SERVICE PROVIDING METHOD USING THE SAME

(71) Applicant: Electronics and Telecommunications Research Institute, Daejeon (KR)

(72) Inventors: Jong Hwan KIM, Daejeon (KR); Sun Sim CHUN, Daejeon (KR); Kee Seong CHO, Daejeon (KR)

(73) Assignee: Electronics and Telecommunications Research Institute, Daejeon (KR)

(21) Appl. No.: 15/633,003

(22) Filed: Jun. 26, 2017

(30) Foreign Application Priority Data
Jun. 24, 2016 (KR) 10-2016-0079397
Jun. 23, 2017 (KR) 10-2017-0079556

(51) Int. Cl. H04L 29/08; H04W 76/02; H04B 1/69; H04J 13/00

(52) U.S. Cl. CPC H04L 29/08; H04W 76/028; H04B 2001/6904; H04J 13/0074

(57) ABSTRACT

Provided is to technology for moving a virtual entity in a virtual network. A method of moving a virtual entity implemented in a virtual network includes providing a service to a user terminal located at a first position by using a virtual entity implemented in a first host located in a first virtual network and when a position of the user terminal is changed, moving the virtual entity to another host capable of providing the service at a close distance to the position-changed user terminal.

### CROSS-REFERENCE TO RELATED APPLICATIONS

This application claims priority under 35 U.S.C. §119 to Korean Patent Application No. 10-2016-0079397, filed on Jun. 24, 2016, and Korean Patent Application No. 10-2017-0079556, filed on Jun. 23, 2017, the disclosure of which is incorporated herein by reference in its entirety.

### TECHNICAL FIELD

The present invention relates to technology for moving a virtual entity in a virtual network, and more particularly, to a method of providing a service while dynamically moving a virtual entity according to a user service context in a virtual network.

### BACKGROUND

In the related art 3G or 4G mobile communication network, as a user terminal moves, a base station accessing the user terminal is changed, but in this case, an error can occur in providing a communication service. Therefore, research and standardization on mobility management for normally providing a communication server to a user despite a base station being changed have been developed at a considerable level.

As technology such as cloud and network function virtualization (NFV) advances, network server infrastructures are virtualized based on software (SW), and thus, it is possible to dynamically generate or move virtual entities for dynamically providing a service.

Therefore, in order to optimally use resources or support a service according to a moving situation of a user or a network condition of a server, a virtual entity can be dynamically moved or reconfigured.

However, a method or standard for dynamically moving a virtual entity is not proposed yet.

Therefore, it is required to develop a method of controlling a movement of a virtual entity providing a service in a virtual network infrastructure, based on a situation change of a user or a situation of a server.

### SUMMARY

Accordingly, the present invention provides a method of providing a service while dynamically moving a virtual entity according to a user service context in a virtual network.

In one general aspect, a method of moving a virtual entity implemented in a virtual network includes: providing a service to a user terminal located at a first position by using a virtual entity implemented in a first host located in a first virtual network; and when a position of the user terminal is changed, moving the virtual entity to another host capable of providing the service at a close distance to the position-changed user terminal.

The moving may include, when the user terminal accesses the first virtual network and moves to a second position provided with the service, moving the virtual entity to a second host located in the first virtual network.

The moving of the virtual entity to the second host may include: requesting a mobility service for the virtual entity, based on the position change of the user terminal; checking a current state of the service and a state of the user terminal; requesting reconfiguration necessary for the movement of the virtual entity, based on a checked result; and moving the virtual entity to the second host, based on the request of the reconfiguration.

The moving of the virtual entity to the second host may further include: adding another virtual entity, which is chained to the virtual entity moved to the second host and provides the service to the user terminal, to the second host; and chaining the other virtual entity to the virtual entity located in the second host.

The moving may include, when the user terminal accesses a second virtual network and moves to a third position provided with the service, moving the virtual entity to a third host located in the second virtual network.

The moving of the virtual entity to the third host may include: requesting a mobility service for the virtual entity, based on the position change of the user terminal; checking a current state of the service and a state of the user terminal; requesting reconfiguration necessary for the movement of the virtual entity, based on a checked result; and based on the request of the reconfiguration, storing a state of the virtual entity, copying the virtual entity to the third host, and starting the virtual entity located in the third host.

The moving of the virtual entity to the third host may further include stopping the virtual entity located in the first network, based on a stop request for the virtual entity located in the first network.

The method may further include, before the providing of the service to the user terminal, registering a state of the user terminal and the current state of the service in a service manager.

The registering may include: requesting, by a service application, provisioning of the service; reading a service profile for obtaining information about the requested service, and operating the virtual entity for providing the requested service; updating a service state, based on a service provisioning result; starting, by the user terminal, a service connection to register a mobility service; and updating a state of the user terminal, based on the registration of the mobility service.

Other features and aspects will be apparent from the following detailed description, the drawings, and the claims.

### BRIEF DESCRIPTION OF THE DRAWINGS

FIG. 1 is a diagram for describing a scenario for providing a service based on virtual entity moving technology in a virtual network according to the present invention.

FIG. 2 is a function block diagram for providing a service based on virtual entity moving technology in a virtual network according to an embodiment of the present invention.

FIGS. 3A and 3B are diagrams for describing a process of registering a service context and context information about a user terminal in a service manager.

FIGS. 4A and 4B are diagrams for a process of moving a virtual entity to different physical hosts in the same network.

FIGS. 5A to 5C are diagrams for describing a process of moving a virtual entity to another network in a case where one mobility enabling function (MEF) module manages a plurality of networks.

FIGS. 6A to 6C are diagrams for describing a process of a virtual entity (VE) to another network in a case where a plurality of MEF modules manage a plurality of networks matching the MEF modules in a one-to-one relationship.

### DETAILED DESCRIPTION OF EMBODIMENTS

In embodiments of the present invention disclosed in the detailed description, specific structural or functional descriptions are merely made for the purpose of describing embodiments of the present invention. Embodiments of the present invention may be embodied in various forms, and the present invention should not be construed as being limited to embodiments of the present invention disclosed in the detailed description.

Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of contextd elements but not the exclusion of any other elements. Also, other expressions describing relationships between components such as “˜between”, “immediately ˜between” or “adjacent to ˜” and “directly adjacent to ˜” may be construed similarly.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the above-described embodiments, all operations may be selectively performed or may be omitted. Also, in the embodiments of the present invention, the order of described operations may be changed, and some elements or features in a specific embodiment may be included in another embodiment or replaced with a corresponding element or feature in another embodiment. Also, the embodiments of the present invention disclosed in the present specification and the drawings are merely specific examples for easily describing the technical details of the present specification and helping understand the present specification, and do not limit the scope of the present specification. That is, it is obvious to those of ordinary skill in the art that various modification embodiments can be implemented based on the technical spirit of the present specification.

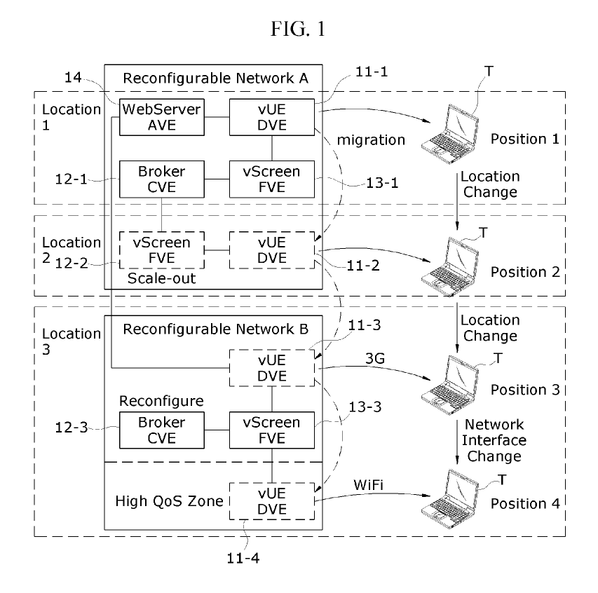

Before describing in detail the present invention, a scenario serviced based on virtual entity moving technology in a virtual network according to the present invention will be first described with reference to FIG. 1.

FIG. 1 is a diagram for describing a scenario for providing a service based on virtual entity moving technology in a virtual network according to the present invention.

In FIG. 1, it is disclosed that as a user moves, a user terminal A may access a network A or a network B and may be provided with a service. The network A and the network B may each be a reconfigurable network.

In this case, the user terminal T may be provided with a service through various virtual entities (VEs) implemented in the network A and the network B.

For example, a device type VE (DVE) 11-1 which is directly connected to the user terminal T and provides a virtual entity service to the user terminal T, a control type VE (CVE) 12-1 which performs access-related control for providing the virtual entity service to the user terminal T, a function type VE (FVE) 13-1 which performs a networking function, and an application type VE (AVE) 14 which performs user access portal management may be implemented in the network A.

The DVE 11-1 may perform a function of providing the virtual entity service, and thus, may be referred to as a virtual user equipment (vUE) DVE. The FVE 13-1 may perform a function of providing a service associated with an access screen, and thus, may be referred to as a virtual screen (vScreen) FVE.

For example, the CVE 12-1 may be implemented with a service broker or a software-defined network (SDN) controller, and the AVE 14 may be implemented with a web server, a database (DB) server, a content server, and/or the like.

The CVE 12-3 and the FVE 13-3 may be implemented in the network B, and in a service providing process based on proposed technology, a plurality of DVEs 11-2, 11-3, and 11-4 and an FVE 13-2 may be further provided.

One AVE 14 may perform a management function for providing a service to the user terminal T, in terms of a whole network including the network A and the network B.

Providing of a service based on a service providing method using a movement of a virtual entity in a virtual network when a network is configured as in FIG. 1 and the user terminal T is located at one or more of first to fourth positions P1 to P4 will be described below.

In this case, it is assumed that the network A provides a service to a service target terminal located in each of a first location Location1 and a second location Location2, and the network B provides a service to a service target terminal located in a third location Location3.

That is, the network A may manage the first location Location1 and the second location Location2, and the network B may manage the third location Location3.

Moreover, it is assumed that the first position P1 is located in the first location Location1, the second position P2 is located in the second location Location2, and the third and fourth positions P3 and P4 are located in the third location Location3.

When the user terminal T is located at the first position P1, the user terminal T may be provided with a service in cooperation with the DVE 11-1 of the network A.

Subsequently, according to the proposed technology, when the user terminal T moves from the first position P1 to the second position P2, the DVE 11-1 may move to a physical host server managing the second location Location2, and thus, the DVE 11-2 may be located in the physical host server, so that a service is provided at a distance close to the user terminal T for providing a service having better quality.

According to the proposed technology, as the DVE 11 moves a physical host server managing the second location Location2, the FVE 13-2 which operates in close cooperation with the DVE 11-2 in a data plain may be generated, and the generated FVE 13-2 may be chained to the DVE 11-2.

Therefore, the user terminal T located at the second position P2 may be provided with a service in cooperation with the DVE 11-2 located in the physical host server managing the second location Location2.

Subsequently, when the user terminal T moves from the second position P2 to the third position P3, a location where the user terminal T is located may be changed from the second location Location2 to the third location Location3.

Therefore, the user terminal T may be provided with a service through the network B managing the third location Location3, and according to the proposed technology, the DVE 11-1 which provides a service in the second location Location2 may move to the network B, whereby the DVE 11-3 may be located in the network B.

Furthermore, the DVE 11-3 located in the network B may be chained to the FVE 13-3 provided in the network B.

Therefore, the user terminal T located at the third position P3 may be provided with a service in cooperation with the DVE 11-3.

Hereinabove, it has been described that when the user terminal moves from the first position P1 to the second position P2 and moves from the second position P2 to the third position P3, a location where the user terminal T is located is changed.

A case where the user terminal T moves from the third position P3 to the fourth position P4 may correspond to a case where only a position is changed, and the user terminal T may be continuously located in the third location Location3.

However, when the user terminal T moves from the third position P3 to the fourth position P4, a network interface which the user terminal T uses may be changed.

That is, the user terminal T may be provided with a service at the third position P3 according to a 3G wireless communication scheme, but the user terminal T may be provided with a service at the fourth position P4 according to a WIFI wireless communication scheme. Also, in order to provide a service having quality suitable for a changed wireless communication scheme, as the DVE 11-3 moves to a WIFI service zone, the DVE 11-4 may be located in the WIFI service zone, and the DVE 11-4 may be chained to the FVE 13-3.

Therefore, the user terminal T at the fourth position P4 may be provided with a service in cooperation with the DVE 11-4.

Through such a scenario, it is possible to provide a close-distance low delay service or a high-quality service, and resource use efficiency increases.

That is, the present invention provides control technology which dynamically moves a virtual entity according to a context change of a user terminal to provide a high-quality service to the user terminal.

Hereinabove, the service providing method using a movement of a virtual entity in a virtual network according to an embodiment of the present invention has been briefly described. Hereinafter, a service providing method using a movement of a virtual entity in a virtual network will be described in more detail.

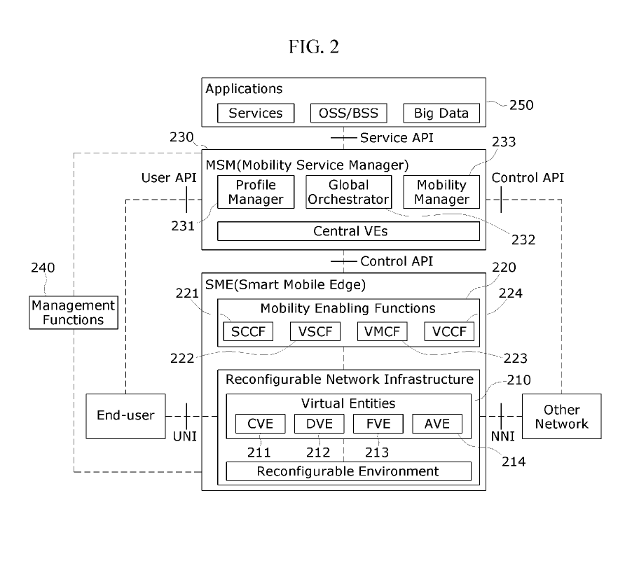

FIG. 2 is a function block diagram for providing a service based on virtual entity moving technology in a virtual network according to an embodiment of the present invention.

The function block diagram illustrated in FIG. 2 illustrates one embodiment for description, and a system for providing a service according virtual entity movement control technology according to an embodiment of the present invention may be implemented as various types.

A service providing method using virtual entity moving technology in a virtual network according to an embodiment of the present invention may be based on cloud-NFV. First, an element-based function of the function block diagram illustrated in FIG. 2 will be described below.

A network 210 may be a reconfigurable network (RN) and may correspond to an infrastructure where a cloud, a virtual network such as an NFV, and a virtual entity (VE) are executed. Various kinds of virtual entities may be implemented in the network 210 to provide a service.

In this case, a control type VE (CVE) 211, a device type VE (DVE) 212, a function type VE (FVE) 213, and an application type VE (AVE) 214 may be implemented in the network 210.

The CVE 211, a control type VE, may be a VE which performs control for providing a service, and for example, may be a service broker or an SDN controller.

The DVE 212, a device type VE, may be a VE which provides service-related information in direct connection with a user terminal, and a virtual desktop infrastructure (VDI) virtual machine (VM) may correspond thereto.

The FVE 213, a function type VE, may be a VE which controls a specific network function for providing a service, and a virtual screen relay VE or a data cache VE may correspond thereto.

The AVE 214, an application type VE, may be a VE which executes application programs for providing a service, and a Web server, a DB server, and a content server may correspond thereto.

The present invention is for providing a high-quality service by moving a virtual entity and proposes various kinds of modules and managers for moving the virtual entity and providing a service.

In detail, a mobility enabling function (MEF) module 220 performing a movement of a VE may include a service connectivity control function (SCCF) module 221, a VE scaling control function (VSCF) module 222, and a VE migration control function (VMCF) module 223, and a VE chaining control function (VCCF) module 224.

The SCCF module 221 may be a module that manages a service connection.

The VSCF module 222 may be a module that performs a function of scaling up or down the number of VEs.

The VMCF module 223 may be a module that performs a function of managing a movement of a VE.

In this case, the VMCF module 223 may perform management on movement between physical hosts and movement between different networks.

The VCCF module 224 may be a module that performs management on chaining between VEs.

A mobility service manager (MSM) 230 may overall manage a plurality of networks and may overall manage processing of a movement request, management of all policies, and determination of a movement method.

In detail, the MSM 230 may include a profile manager (PM) 231, a global orchestrator (GO) 232, and a mobility manager (MM) 233.

The profile manager 231 may store and manage information (context information) about a context of a VE which is currently providing a service and information (context information) about a context of a user terminal which is provided with the service.

The global orchestrator 232 may determine a reconfiguration method for a network for performing a movement of a VE and performs a movement of the VE.

In this case, the global orchestrator 232 may perform processing associated with a movement of the VE in cooperation with the MEF module 220.

The mobility manager 233 may receive a movement request for the VE, read current context information (context information about the VE and context information about a user terminal) and authentication/authorization information from the profile manager 231 for processing the movement request, determine a movement method based on a policy and/or the like, and request movement processing of the VE from the global orchestrator 232.

A management module 240 may perform a function of managing a network infrastructure. For example, an orchestrator in a cloud may correspond to the management module 240, and a management and orchestrator (MANO) in an NFV may correspond to the management module 240.

An application 250 may be a third application program that requests a service, and may be developed and operated based on the content and purpose of the service by using an interface for function blocks provided by service providers.

In this case, the application 250 may be connected to the MSM 230 to request the service through an application program interface with a service provider, a business interface including OSS/BSS, and an engineering interface including an analysis component such as big data analysis, and/or the like.

Hereinabove, the elements for performing a function of providing a service based on virtual entity moving technology in a virtual network have been described. Hereinafter, a service providing operation using a movement of a virtual entity in a virtual network according to an embodiment of the present invention will be described in detail.

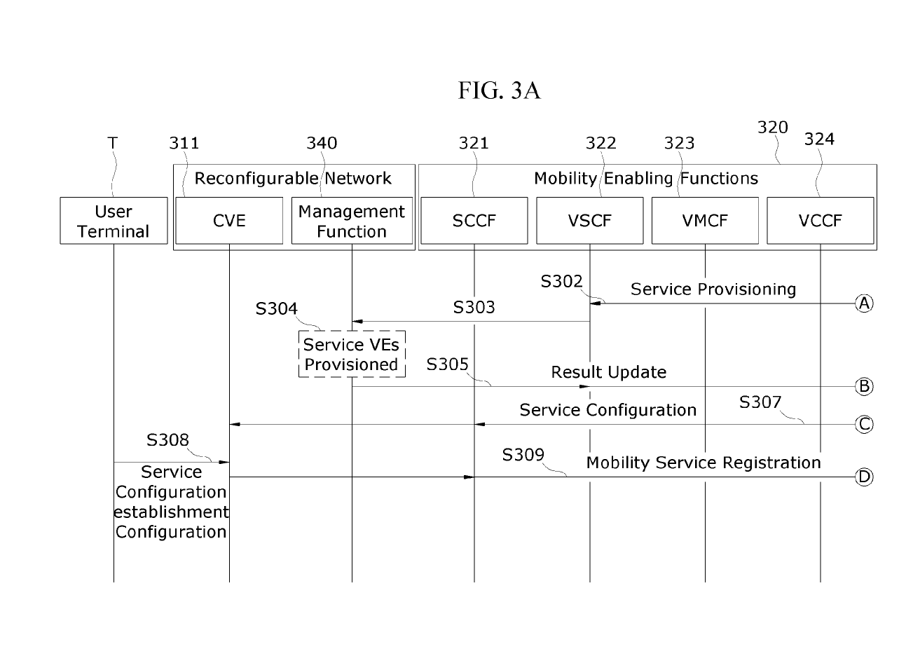

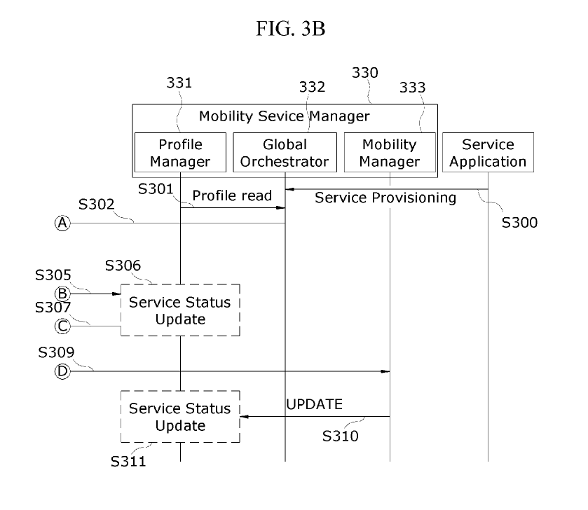

FIGS. 3A and 3B are diagrams for describing a process of registering a service context and context information about a user terminal in a service manager.

In order to provide an appropriate service depending on a movement of a user terminal, a current context of the service and context information about the user terminal should be registered in a service manager.

A process of registering the current context of the service and the context information about the user terminal in the service manager will be described below with reference to FIGS. 3A and 3B.

First, in step S300, a service application may request service provisioning of a service from a global orchestrator 332.

Therefore, in step S301, the global orchestrator 332 may read a service profile from a profile manager 331, for obtaining information about the request service.

Subsequently, the global orchestrator 332 may request provisioning of a service from a VSCF module 322 of a network corresponding to the requested service in step S302 and may transmit a service provisioning request to a management module 340 in step S303, and the management module 340 may operate a VE for providing the service.

Subsequently, the management module 340 may transmit a service provisioning result to the profile manager 331 in step S305, and thus, a service context in the profile manager 331 may be updated in step S306.

At this time, the service provisioning result from the management module 340 may be transmitted to the profile manager 331 via the VSCF module 322.

Subsequently, in step S307, the profile manager 331 may notify a CVE 311 of a service context obtained through the updating, and thus, the CVE 311 may be configured based on the service context from the profile manager 331 and may prepare for providing a service to a user terminal T.

Subsequently, the user terminal T may start a service connection and may register a mobility service in the CVE 311 in step S308, and the CVE 311 may transmit a mobility service registration request to a mobility manager 333 in step S309.

At this time, the mobility service registration request from the CVE 311 may be transmitted to the mobility manager 333 via an SCCF module 321.

Also, the mobility manager 333 may transmit activation information about a user movement service and a service to the profile manager 331 in step S310, and thus, a service context in the profile manager 331 may be updated in step S311.

In this manner, the profile manager 231 may store and manage information (context information) about a context of a VE which is currently providing a service and information (context information) about a context of a user terminal which is provided with the service.

Hereinabove, a process of registering service context information and context information about a user terminal in a service manager has been described. Hereinafter, a process of moving a VE in a state where the service context information and the context information about the user terminal have been registered in the service manager according to the above-described process will be described.

In order to move a VE to different physical hosts in the same network or to move a VE to different physical hosts between different networks, the function modules illustrated in FIG. 2 may operate in cooperation with each other. Hereinafter, therefore, a process of moving a VE through cooperation between the function modules illustrated in FIG. 2 will be described.

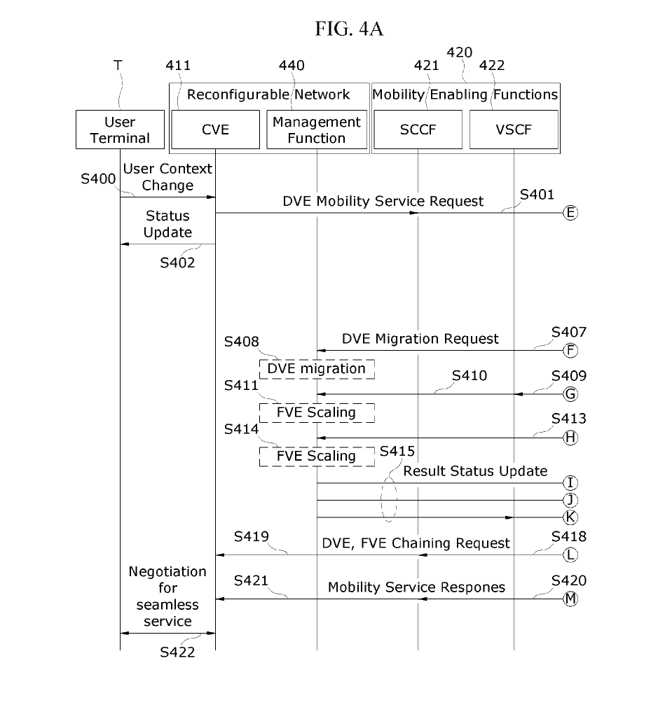

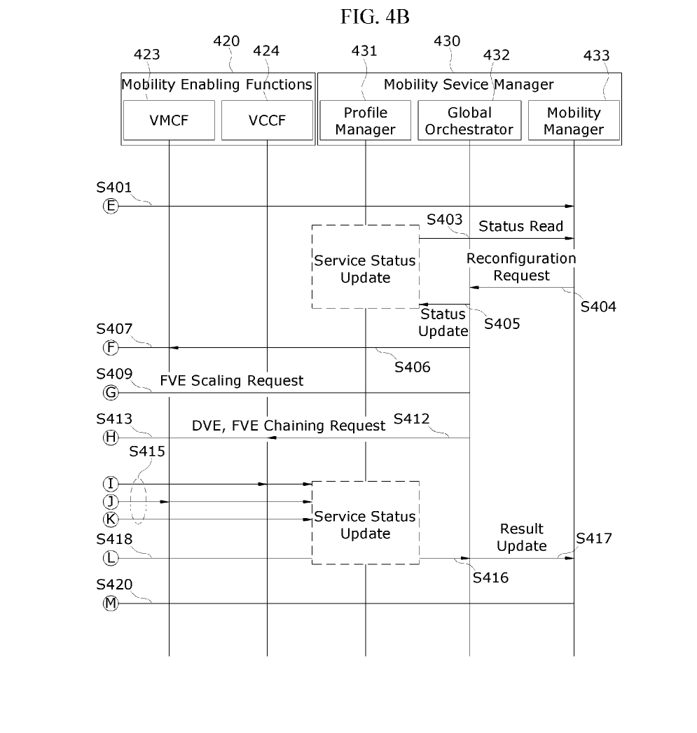

FIGS. 4A and 4B are diagrams for a process of moving a virtual entity to different physical hosts in the same network.

A scenario associated with the process of FIGS. 4A and 4B denotes that a position change of a user causes a movement of a DVE, and thus, a distance between a user terminal and the DVE becomes shorter.

However, a movement of a VE may be caused by various context changes of a user including a position, QoS, and/or the like. In a DVE moving process, an FVE corresponding to the DVE may extend to be chained to the DVE at a close position.

A process (for example, a case where the user terminal moves from the first position to the second position in FIG. 1) of moving a VE to different physical hosts in the same network will be described.

First, when a context (for example, a position) of a user terminal T is changed, a CVE 411 may sense the position change of the user terminal T in step S400.

Subsequently, the CVE 411 may transmit a mobility service request to the mobility manager 433 through an SCCF module 421 in step S401, and then, may notify the user terminal T that a movement of the DVE is to be started in step S402.

Subsequently, the mobility manager 433 may read and check a state of the user terminal T and a service from a profile manager 431 in step S403 and may request performing of reconfiguration necessary for a movement of the DVE to a global orchestrator 432 in step S404. Also, in step S405, the global orchestrator 432 may notify the profile manager 431 that the performing of the reconfiguration is started.

Subsequently, the global orchestrator 432 may transmit a DVE movement request to a VMCF module 423 in step S406, and the VMCF module 423 may transmit the DVE movement request to a management module 240 in step S407.

Therefore, in step S408, the management module 440 may move the DVE to a new physical host to which the DVE is to be moved.

Moreover, the global orchestrator 432 may transmit an FVE scaling request to a VSCF module 422 in step S409, and the VSCF module 422 may transmit the FVE scaling request to the management module 440 in step S410.

Therefore, in step S411, the management module 440 may add an FVE to a new physical host to which the DVE has been moved in step S408.

Moreover, the global orchestrator 432 may transmit a chaining request, which issues a request to chain the FVE to the DVE which is located in the new physical host in steps S408 and S411, to the VCCF module 424 in step S412, and the VCCF module 424 may transmit the chaining request to the management module 440.

Therefore, in step S414, the management module 440 may chain the FVE to the DVE located in the new physical host.

In step S415, the management module 440 may transmit a performed result (the movement of the DVE, the scaling of the FVE, and the chaining between the DVE and the FVE) to the profile manager 431.

At this time, the management module 440 may transmit a movement context of the DVE to the profile manager 431 through a VMCF module 423, transmit a scaling context of the FVE to the profile manager 431 through the VSCF module 422, and transmit a chaining context between the DVE and the FVE to the profile manager 431 through the VCCF module 424.

In steps 416 and 417, the profile manager 431 may transmit a performed result of the management module 440 to the global orchestrator 432 and a mobility manager 433.

Subsequently, the profile manager 431 may transmit the performed result of the management module 440 to a CVE 411 through the SCCF module 421 in steps S418 and S419, and the mobility manager 433 may transmit the performed result of the management module 440 to a CVE 411 through the SCCF module 421 in steps S420 and S421.

Subsequently, based on the performed result of the management module 440, the CVE 411 may provide a smooth service to a user terminal in step S422.

That is, according to an operation illustrated in FIGS. 4A and 4B, when a context (for example, a position) of a user terminal is changed, in order to provide an optimal service to the context-changed user terminal, the DVE and the FVE may be located in a physical host (through movement and generation) in a location which enables the optimal service to be provided.

For example, as in FIG. 1, when the user terminal T moves from the first position P1 to the second position P2, the DVE 11-2 and the FVE 13-2 may be newly located in a physical host in the second location Location2.

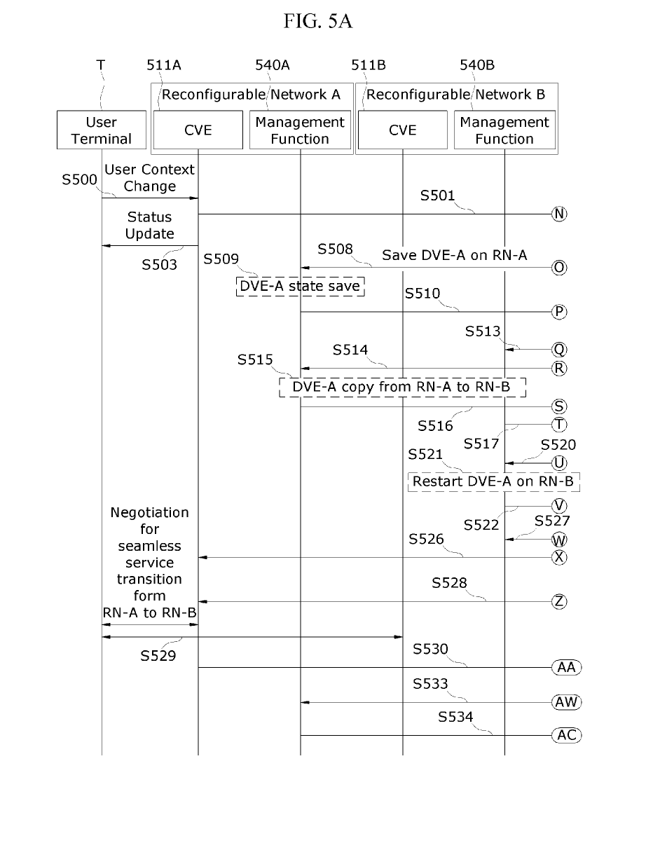

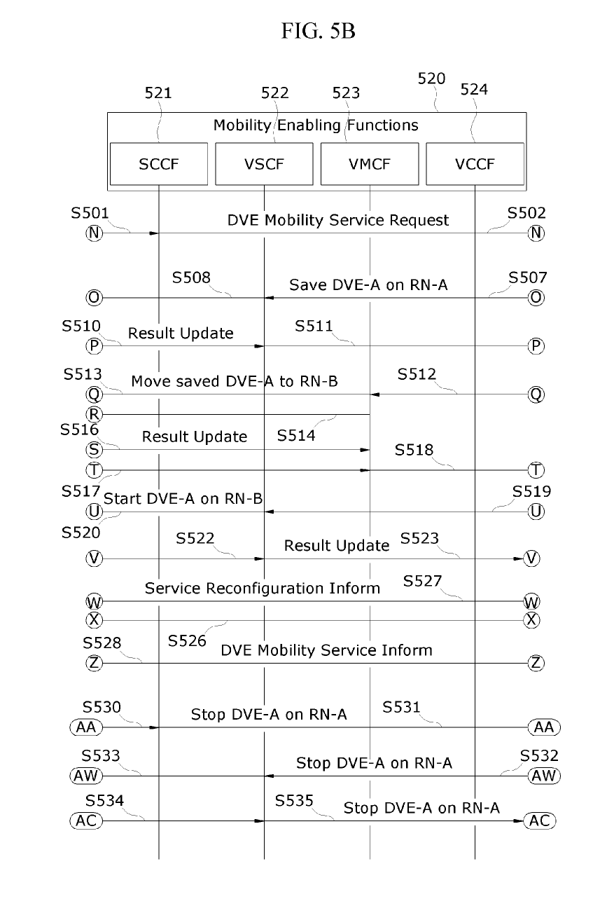

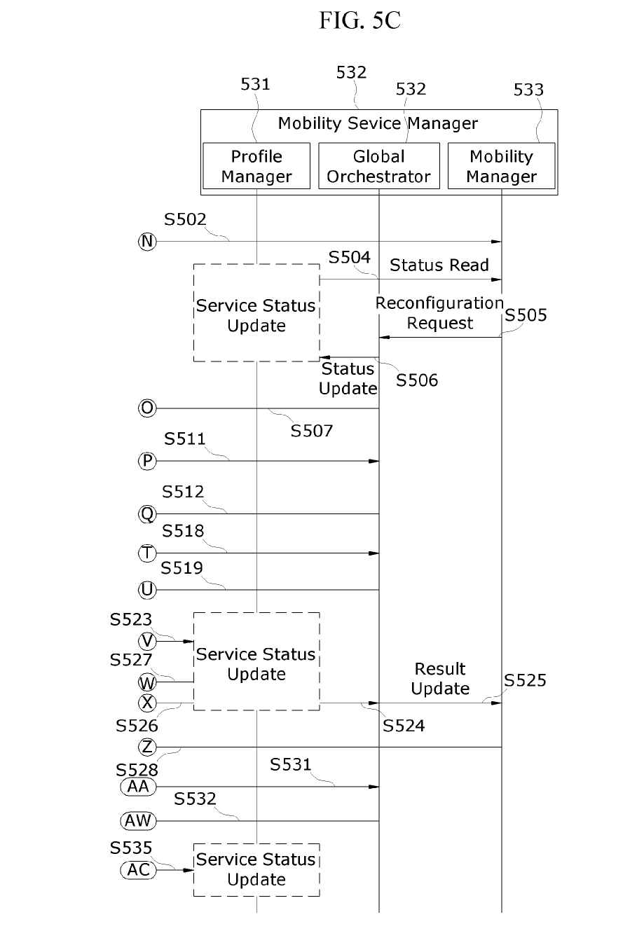

FIGS. 5A to 5C are diagrams for describing a process of moving a virtual entity to another network in a case where one mobility enabling function (MEF) module manages a plurality of networks.

A process (for example, a case where a user terminal moves from a second position to a third position) of moving a VE to another network in a case where one MEF module manages a plurality of networks (for example, a network A and a network B) will be described below with reference to FIGS. 5A to 5C.

First, when a context (for example, a position) of a user terminal T is changed, a CVE (a first CVE) 511A of a network A (or a first network) accessing the user terminal T may sense a context change of the user terminal T in step S500.

Subsequently, the first CVE 511A may transmit a mobility service request for a DVE to a mobility manager 533 through an SCCF module 521 in steps S501 and S502, and then, may notify the user terminal T that a movement of the DVE is to be started in step S503.

Subsequently, the mobility manager 533 may read and check a state of the user terminal T and a service from a profile manager 531 in step S504 and may request performing of reconfiguration necessary for a movement of the DVE to a global orchestrator 532 in step S505. Also, in step S506, the global orchestrator 532 may notify the profile manager 531 that the performing of the reconfiguration is started.

Subsequently, the global orchestrator 532 may issue a request, to a management module (a first management module) 540A of the network A through a VSCF module 522, to store a state of a DVE (a DVE-A) included in the network A in steps S507 and S508.

Therefore, the first management module 540A may store a state of the DVE-A in step S509 and may transmit a performed result to the global orchestrator 532 through the VSCF module 522 in steps S510 and S511.

Subsequently, the global orchestrator 532 may transmit a movement request, which issues a request to move the DVE-A from the network A to the network B (or a second network), to the first management module 540A and a management module (a second management module) 540B of the network B through a VMCF module 523 in steps S512, S513, and S514.

Therefore, the first and second management modules 540A and 540B may copy the DVE-A from the network A to the network B in step S515 and may transmit a performed result to the global orchestrator 532 through the VMCF module 523 in steps S516, S517, and S518.

Subsequently, the global orchestrator 532 may transmit a start request for the DVE-A, located in the network B, to the second management module 540B through the VSCF module 522 in steps S519 and S520.

Subsequently, the second management module 540B may perform start on the DVE-A located in the network B in step S521 and may transmit a performed result to the profile manager 531 through the VSCF module 522 in steps S522 and S523.

Therefore, the profile manager 531 may update a service state and may transmit the performed result, received from the second management module MOB, to the global orchestrator 532 and the mobility manager 533 in steps S524 and S525.

Therefore, the global orchestrator 532 and the mobility manager 533 may update the service state, based on information (i.e., the performed result of the second management module 540B) from the profile manager 531.

Moreover, the profile manager 531 may transmit the performed result of the second management module 540B to the first CVE 511A and a CVE (a second CVE) 511B of the network B through the SCCF module 521 in steps S526 and S527.

The mobility manager 533 may transmit a response to the mobility service request, transmitted in steps S501 and S502, to the first CVE 511A through the SCCF module 521 in step S528.

The DVE-A may move from the network A to the network B through the above-described process, and then, the second CVE 511B may provide a smooth service to a user terminal in step S529.

The movement of the VE may be repeatedly performed for providing a smooth service to the user terminal.

After an operation of copying the DVE-A to the network B is completed, the first CVE 511A may transmit a stop request for the DVE-A of the network A to the global orchestrator 532 through the SCCF module 521 in steps S530 and S531.

Therefore, the global orchestrator 532 may transmit the stop request to the first management module 540A through the VSCF module 522 in steps S532 and S533, and then, the first management module 540A may perform stop on the DVE-A of the network A and may transmit a performed result to the profile manager 531 through the VSCF module 522 in steps 534 and S535.

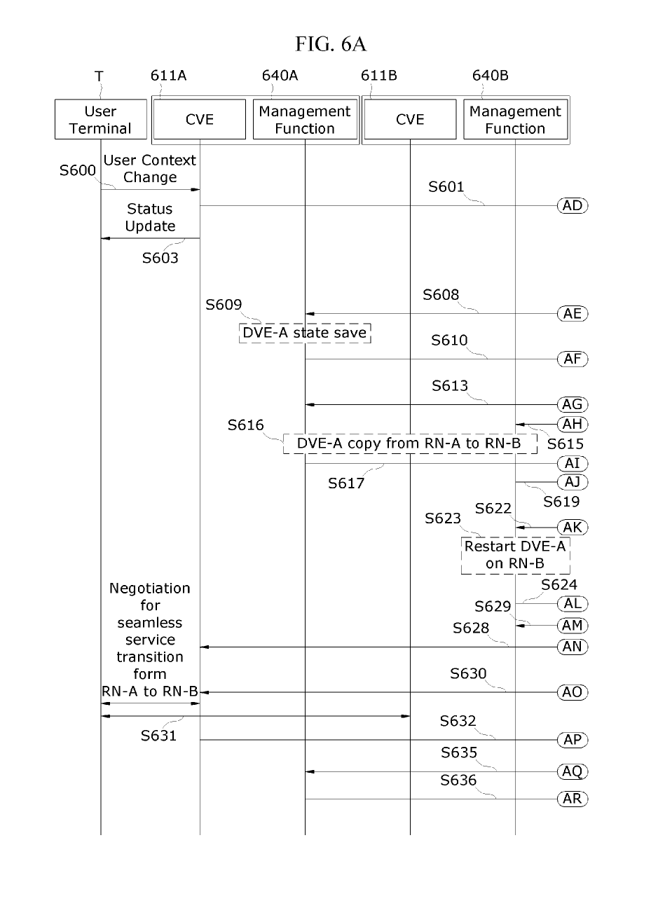

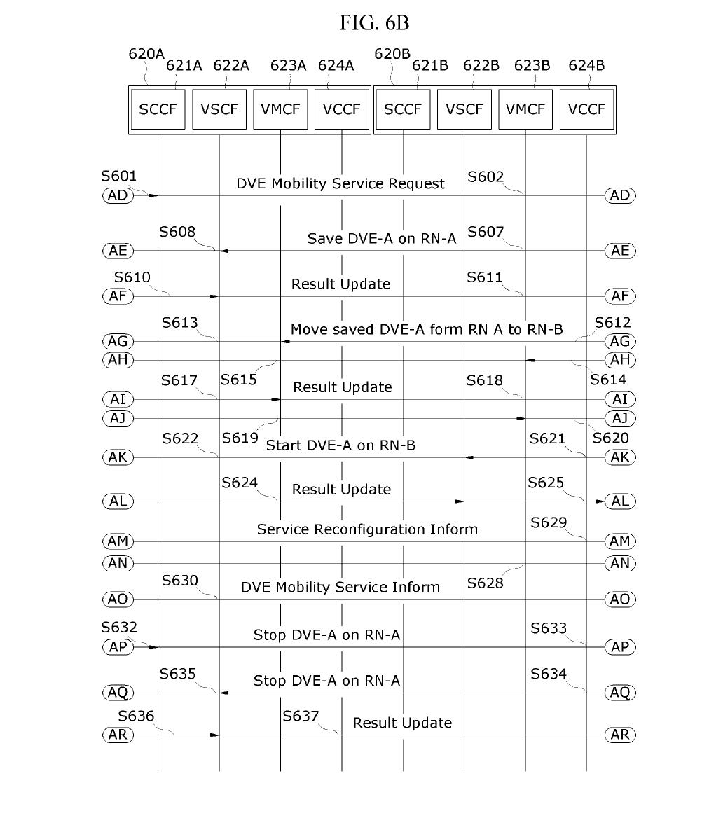

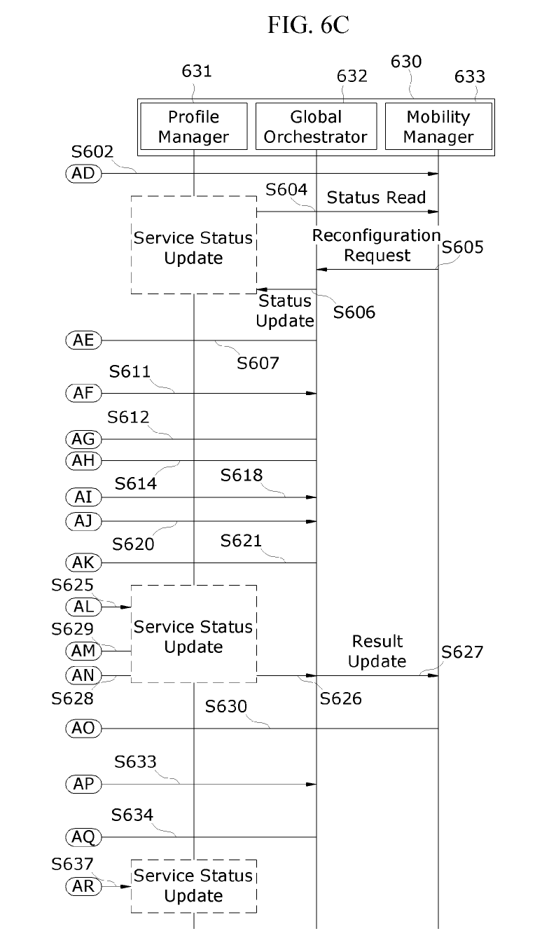

FIGS. 6A to 6C are diagrams for describing a process of a virtual entity (VE) to another network in a case where a plurality of MEF modules manage a plurality of networks matching the MEF modules in a one-to-one relationship.

As checked in FIGS. 6A to 6C, an operation performed in each step is similar to an operation in FIGS. 5A to 5C.

There is a difference in that one MEF module moves a VE in cooperation with the network A and the network B in FIGS. 5A to 5C, but in FIGS. 6A to 6C, an MEF module cooperating with the network A and an MEF module cooperating with the network B are provided.

Referring to FIGS. 6A to 6C, when a context (for example, a position) of a user terminal T is changed, a CVE (a first CVE) 611A of a network A (or a first network) accessing the user terminal T may sense a context change of the user terminal T in step S600.

Subsequently, the first CVE 611A may transmit a mobility service request for a DVE to a mobility manager 633 through an SCCF module 621A of a first MEF module 620A in steps S601 and S602, and then, may notify the user terminal T that a movement of the DVE is to be started in step S603.

Subsequently, the mobility manager 633 may read and check a state of the user terminal T and a service from a profile manager 631 in step S604 and may request performing of reconfiguration necessary for a movement of the DVE to a global orchestrator 632 in step S605. Also, in step S606, the global orchestrator 632 may notify the profile manager 631 that the performing of the reconfiguration is started.

Subsequently, the global orchestrator 632 may issue a request, to a management module (a first management module) 640A of the network A through a first VSCF module 622A, to store a state of a DVE (a DVE-A) included in the network A in steps S607 and S608.

Therefore, the first management module 640A may store a state of the DVE-A in step S609 and may transmit a performed result to the global orchestrator 632 through the first VSCF module 622A in steps S610 and S611.

Subsequently, the global orchestrator 632 may transmit a movement request, which issues a request to move the DVE-A from the network A to the network B (or a second network), to the first management module 640A and a management module (a second management module) 640B of the network B.

In this case, the global orchestrator 632 may transmit the movement request to the first management module 640A through a first VMCF 623A of the first MEF module 620A in steps S612 and S613 and may transmit the movement request to the second management module 640B through a second VMCF 623B of the second MEF module 620B in steps S614 and S615.

Therefore, the first and second management modules 640A and 640B may copy the DVE-A from the network A to the network B in step S616 and may transmit a performed result to the global orchestrator 632.

In this case, the first management module 640A may transmit a performed result through the first VMCF module 623A in steps S617 and S618, and the second management module 640B may transmit a performed result through the second VMCF module 623B in steps S619 and S620.

Subsequently, the global orchestrator 632 may transmit a start request for the DVE-A, located in the network B, to the second management module 640B through the second VSCF module 622B in steps S621 and S622.

Subsequently, the second management module 640B may perform start on the DVE-A located in the network B in step S623 and may transmit a performed result to the profile manager 631 through the second VSCF module 622B in steps S624 and S625.

Therefore, the profile manager 631 may update a service state and may transmit the performed result, received from the second management module 640B, to the global orchestrator 632 and the mobility manager 633 in steps S626 and S627.

Therefore, the global orchestrator 632 and the mobility manager 633 may update the service state, based on information (i.e., the performed result of the second management module 640B) from the profile manager 631.

Moreover, the profile manager 631 may transmit the performed result of the second management module 640B to the first CVE 611A and a CVE (a second CVE) 611B of the network B.

In this case, the profile manager 631 may transmit the performed result of the second management module 640B to the first CVE 611A through the first SCCF module 621A in step S628 and may transmit the performed result of the second management module 640B to the second CVE 611B through the second SCCF module 621B in step S629.

The mobility manager 633 may transmit a response to the mobility service request, transmitted in steps S601 and S602, to the first CVE 611A through the first SCCF module 621A in step S630.

The DVE-A may move from the network A to the network B through the above-described process, and then, the second CVE 611B may provide a smooth service to a user terminal in step S631.

The movement of the VE may be repeatedly performed for providing a smooth service to the user terminal.

After an operation of copying the DVE-A of the network A to the network B is completed, the first CVE 611A may transmit a stop request for the DVE-A of the network A to the global orchestrator 632 through the first SCCF module 621A in steps S632 and S633.

Therefore, the global orchestrator 632 may transmit the stop request to the first management module 640A through the first VSCF module 622A in steps S634 and S635, and then, the first management module 640A may perform stop on the DVE-A of the network A and may transmit a performed result to the profile manager 631 through the first VSCF module 622A in steps 636 and S637.

The virtual entity moving method and the service providing method according to the embodiments of the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

The method of moving virtual entity in virtual network and the service providing method using the same have been described according to the embodiments, but the scope of the present invention is not limited to a specific embodiment. The present invention may be corrected and modified within the technical scope obvious to those skilled in the art.

As described above, according to the embodiments of the present invention, a virtual entity providing a service may be moved to a position close to a user terminal while the user terminal is moving, or a virtual network may be reconfigured based on a context of the user terminal, thereby enhancing service quality and enhancing a resource efficiency of the virtual network and the server.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of moving a virtual entity implemented in a virtual network, the method comprising:
providing a service to a user terminal located at a first position by using a virtual entity implemented in a first host located in a first virtual network; and
when a position of the user terminal is changed, moving the virtual entity to another host capable of providing the service at a close distance to the position-changed user terminal.

2. The method of claim 1, wherein the moving comprises, when the user terminal accesses the first virtual network and moves to a second position provided with the service, moving the virtual entity to a second host located in the first virtual network.

3. The method of claim 2, wherein the moving of the virtual entity to the second host comprises:
requesting a mobility service for the virtual entity, based on the position change of the user terminal;
checking a current state of the service and a state of the user terminal;
requesting reconfiguration necessary for the movement of the virtual entity, based on a checked result; and
moving the virtual entity to the second host, based on the request of the reconfiguration.

4. The method of claim 3, wherein the moving of the virtual entity to the second host further comprises:
adding another virtual entity, which is chained to the virtual entity moved to the second host and provides the service to the user terminal, to the second host; and
chaining the other virtual entity to the virtual entity located in the second host.

5. The method of claim 1, wherein the moving comprises, when the user terminal accesses a second virtual network and moves to a third position provided with the service, moving the virtual entity to a third host located in the second virtual network.

6. The method of claim 5, wherein the moving of the virtual entity to the third host comprises:
requesting a mobility service for the virtual entity, based on the position change of the user terminal;
checking a current state of the service and a state of the user terminal;
requesting reconfiguration necessary for the movement of the virtual entity, based on a checked result; and
based on the request of the reconfiguration, storing a state of the virtual entity, copying the virtual entity to the third host, and starting the virtual entity located in the third host.

7. The method of claim 6, wherein the moving of the virtual entity to the third host further comprises stopping the virtual entity located in the first network, based on a stop request for the virtual entity located in the first network.

8. The method of claim 1, further comprising, before the providing of the service to the user terminal, registering a state of the user terminal and the current state of the service in a service manager.

9. The method of claim 8, wherein the registering comprises:
requesting, by a service application, provisioning of the service;
reading a service profile for obtaining information about the requested service, and operating the virtual entity for providing the requested service;
updating a service state, based on a service provisioning result;
starting, by the user terminal, a service connection to register a mobility service; and
updating a state of the user terminal, based on the registration of the mobility service.
